(19) United States
(12) Patent Application Publication
(10) Pub. No.: US 2026/0039937 A1
(43) Pub. Date: Feb. 5, 2026

(54) IMAGING APPARATUS

(71) Applicant: CANON KABUSHIKI KAISHA, Tokyo (JP)

(72) Inventor: TAKASHI YOSHIDA, Kanagawa (JP)

(21) Appl. No.: 19/354,655

(22) Filed: Oct. 9, 2025

Related U.S. Application Data
(63) Continuation of application No. PCT/JP2024/012953, filed on Mar. 29, 2024.

(30) Foreign Application Priority Data
Apr. 12, 2023 (JP) 2023-064771

(51) Int. Cl. H04N 23/53; G01P 15/18

(52) U.S. Cl. CPC H04N 23/531; G01P 15/18

(57) ABSTRACT

An imaging apparatus includes a main body part including an imaging unit, a display part, a rotation unit, a first detection unit, a second detection unit, and a calculation unit, wherein, in a case where a first opening/closing angle range is determined by the calculation unit, a first display state is displayed on the display part, wherein, in a case where a second opening/closing angle range is determined by the calculation unit, a second display state is displayed on the display part, and wherein, in a case where a third opening/closing angle range is determined by the calculation unit, the first display state or the second display state is displayed on the display part in accordance with a tilt angle of the main body part with respect to gravity or a tilt angle of the display part with respect to gravity.

### CROSS-REFERENCE TO RELATED APPLICATIONS

This application is a Continuation of International Patent Application No. PCT/JP2024/012953, filed Mar. 29, 2024, which claims the benefit of Japanese Patent Application No. 2023-064771, filed Apr. 12, 2023, both of which are hereby incorporated by reference herein in their entirety.

### BACKGROUND

### Field of the Technology

The present disclosure relates to an imaging apparatus having a movable display part.

### Description of the Related Art

Recent imaging apparatuses such as digital cameras include a display part including a liquid crystal display, etc., to display a subject to be captured.

In addition, many imaging apparatuses include a rotatable display part, to support image capturing from various angles.

When a photographer performs self-photographing to capture himself/herself as a subject, the photographer rotates the display part from a closed state for regular photographing to an open state for self-photographing. In this way, the photographer can capture himself/herself while checking an image to be captured on the display part.

For this type of imaging apparatuses, there is known a technique for enabling the display part to automatically switch between “normal display” in which the photographer views the image from the photographer side and “inverted display” in which the photographer views the image from the subject side.

For example, in Japanese Patent Laid-Open No. 2016-187221, the opening and closing of the display part is detected by using a magnetic field sensor and a magnet.

Specifically, Japanese Patent Laid-Open No. 2016-187221 describes switching the display from “normal display” to “inverted display” based on the detection result and allowing the user to easily check whether the set values of the parameters used for photographing are set as desired by displaying the parameters necessary for photographing.

The conventional technique described in the above patent document enables desired display in a closed state for regular photographing, that is, in a state where the opening/closing angle of the display part is 0°, and in an open state for self-photographing, that is, in a state where the opening/closing angle of the display part is 180°.

However, the conventional technique has a problem in that desired display is not always obtained when the optical axis of the imaging apparatus is directed upward (upward angle photographing) or downward (downward angle photographing) between the opening and closing of the display part at an opening/closing angle between 0° and 180°.

The present disclosure is directed to providing an imaging apparatus capable of obtaining desired display matching the direction of the optical axis of the imaging apparatus and the opening/closing angle of a display part.

### SUMMARY

According to an aspect of the present disclosure, an imaging apparatus includes a main body part configured to include an imaging unit, a display part configured to change its posture with respect to the main body part, a rotation unit configured to rotatably hold the display part with respect to the main body part, a first detection unit configured to detect information about gravitational acceleration applied to the main body part, a second detection unit configured to detect information about gravitational acceleration applied to the display part, and a calculation unit configured to calculate an opening/closing angle of the display part with respect to the main body part based on acceleration signals acquired from the first detection unit and the second detection unit, wherein the opening/closing angle of the display part is divided into a first opening/closing angle range, a second opening/closing angle range, and a third opening/closing angle range, wherein the third opening/closing angle range is formed between the first opening/closing angle range and the second opening/closing angle range, wherein, in a case where the first opening/closing angle range is determined by the calculation unit, a first display state is displayed on the display part, wherein, in a case where the second opening/closing angle range is determined by the calculation unit, a second display state is displayed on the display part, and wherein, in a case where the third opening/closing angle range is determined by the calculation unit, the first display state or the second display state is displayed on the display part in accordance with a tilt angle of the main body part with respect to gravity or a tilt angle of the display part with respect to gravity.

Features of the present disclosure will become apparent from the following description of embodiments with reference to the attached drawings.

### BRIEF DESCRIPTION OF THE DRAWINGS

FIG. 1A is a front perspective view of a digital camera according to the present disclosure.

FIG. 1B is a rear perspective view of the digital camera according to the present disclosure.

FIG. 2 is a block diagram of the digital camera according to the present disclosure.

FIG. 3 is an exploded perspective view of the digital camera according to the present disclosure.

FIG. 4 is an exploded perspective view of a display part according to the present disclosure.

FIG. 5A is a rear view of an electronic circuit board according to the present disclosure.

FIG. 5B is a front view of the electronic circuit board according to the present disclosure.

FIG. 6 is a detailed block diagram relating to the display part according to the present disclosure.

FIG. 7A is a right side view illustrating an open/closed state of the display part of the digital camera according to the present disclosure.

FIG. 7B is a right side view illustrating an open/closed state of the display part of the digital camera according to the present disclosure.

FIG. 7C is a right side view illustrating an open/closed state of the display part of the digital camera according to the present disclosure.

FIG. 7D is a right side view illustrating an open/closed state of the display part of the digital camera according to the present disclosure.

FIG. 8A is a rear view schematically illustrating an image on a display according to the present disclosure.

FIG. 8B is a front view schematically illustrating the image on the display according to the present disclosure.

FIG. 8C is a front view schematically illustrating the image on the display according to the present disclosure.

FIG. 9 is a flowchart illustrating display switching determination according to the present disclosure.

FIG. 10A illustrates the digital camera according to the present disclosure in the state of upward angle photographing.

FIG. 10B illustrates the state of the display part of the digital camera according to the present disclosure.

FIG. 11A illustrates the digital camera according to the present disclosure in the state of downward angle photographing.

FIG. 11B illustrates the state of the display part of the digital camera according to the present disclosure.

FIG. 12A schematically illustrates display part opening/closing angles according to the present disclosure, without a posture detection range.

FIG. 12B schematically illustrates display part opening/closing angles according to the present disclosure, without a posture detection range.

FIG. 12C schematically illustrates display part opening/closing angles according to the present disclosure, without a posture detection range.

FIG. 13A schematically illustrates display part opening/closing angles according to the present disclosure, without an opening detection range or closing detection range.

FIG. 13B schematically illustrates display part opening/closing angles according to the present disclosure, without an opening detection range or closing detection range.

FIG. 13C schematically illustrates display part opening/closing angles according to the present disclosure, without an opening detection range or closing detection range.

### DESCRIPTION OF THE EMBODIMENTS

Hereinafter, embodiments relating to the present disclosure will be described in detail with reference to the drawings. In the drawings, the same members are denoted by the same reference characters.

### First Embodiment

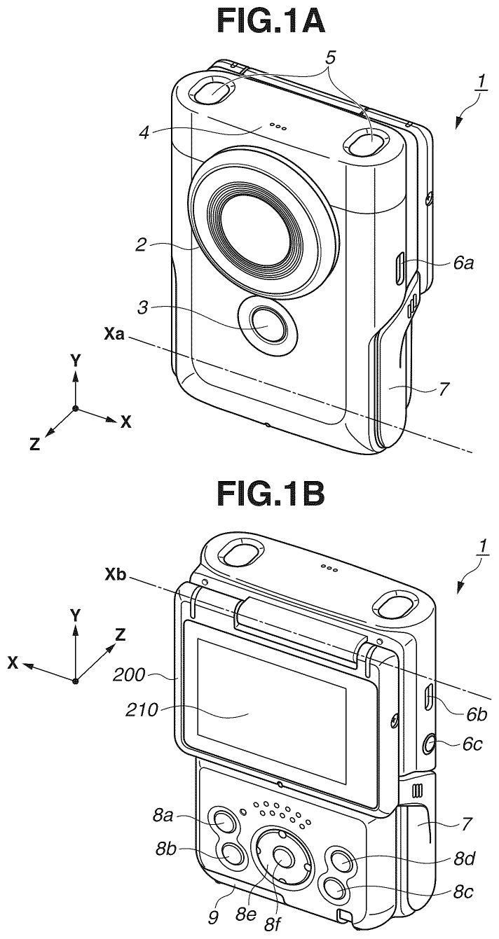

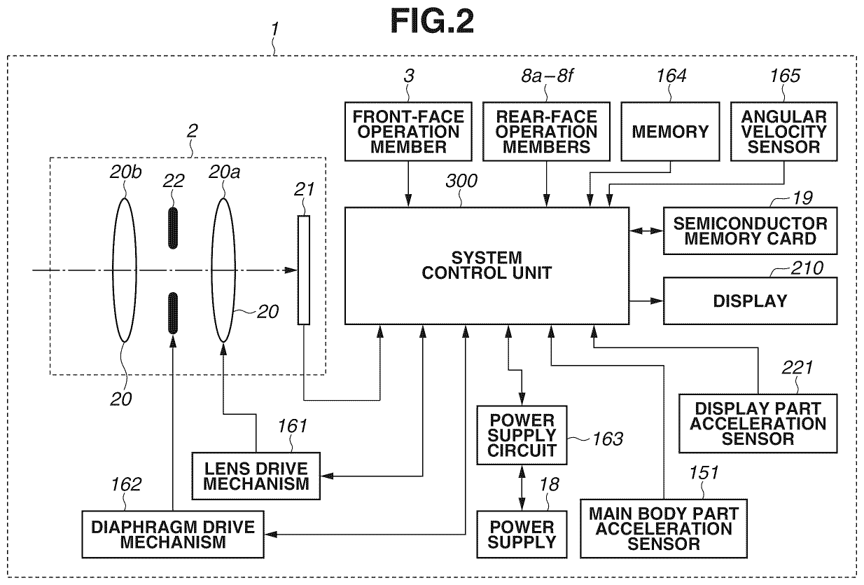

A digital camera 1, which is an imaging apparatus according to the present disclosure, will be described with reference to FIGS. 1A, 1B, and 2. FIG. 1A is a front perspective view of the digital camera 1. FIG. 1B is a rear perspective view of the digital camera 1. FIG. 2 is a block diagram illustrating a main functional configuration of the digital camera 1.

### (Perspective Views of Digital Camera 1)

As illustrated in FIGS. 1A and 1B, regarding the digital camera 1, the X direction, the Y direction, and the Z direction are defined as follows. The horizontal direction (width direction) of the digital camera 1 is defined as the X direction. The vertical direction (height direction) of the digital camera 1 is defined as the Y direction. The front-to-back direction (thickness direction) of the digital camera 1 is defined as the Z direction.

A lens barrel unit 2 for capturing a subject image is disposed on the upper side of the front face of the digital camera 1.

The lens barrel unit 2 includes an image sensor 21 that photoelectrically converts an optical image of a subject formed via a plurality of imaging lenses 20 constituting an imaging optical system, so as to generate image data (see FIG. 2).

A front-face operation member 3 for instructing image capturing is disposed under the lens barrel unit 2. The front-face operation member 3 is disposed near the center of the front face such that the photographer can easily operate the front-face operation member 3 when performing self-photographing to capture himself/herself as a subject.

The front-face operation member 3 functions as a shutter button when the digital camera 1 is in a still image shooting mode, and functions as a video shooting start/stop button when the digital camera 1 is in a video shooting mode.

A speaker 4 is disposed near the center on the top face of the digital camera 1. The speaker 4 outputs an operation sound and replays the sound of a recorded video. Microphones 5 are disposed at the right and left ends on the top face of the digital camera 1. The microphones 5 collect sound during video shooting.

External terminal connectors 6a to 6c are disposed on the upper side of the side faces of the digital camera 1.

The external terminal connectors 6a to 6c are, for example, a universal serial bus (USB) terminal capable of performing data communication, charging, and power feeding, a high-definition multimedia interface (HDMI (registered trademark)) terminal capable of outputting video data to the outside, and an external microphone connection terminal capable of receiving an external microphone signal.

Further, a rotatable stand unit 7 is disposed on the lower side, and FIGS. 1A and 1B illustrate the stand unit 7 in the stowed position. The stand unit 7 can be rotated approximately 320° about a rotational axis Xa parallel to the X axis.

This allows the digital camera 1 to be tilted upward or downward, and enables fixed camera shooting from various angles.

A movable display part 200 is disposed on the upper side of the rear face of the digital camera 1, and FIGS. 1A and 1B illustrate the display part 200 in a stowed state, that is, in a closed state.

The display part 200 includes a display 210.

The display 210 can perform various kinds of displays such as display of a live view image captured by the image sensor 21, display of menu settings, and display of a captured image. The display 210 is a device such as a liquid crystal display (LCD) or an organic electroluminescent (EL) (organic light-emitting diode (OLED)) display.

The display 210 incudes capacitive or pressure-sensitive touch panel, and has a touch operation function that allows the photographer to perform various kinds of operations by performing touch operations with a finger or the like.

The display part 200 can be rotated approximately 180° about a rotational axis Xb parallel to the X axis.

With this structure, when the photographer performs self-photographing to capture himself/herself as a subject, the photographer can capture an image while checking the composition on the display part 200.

A configuration of the display part 200 will be described in detail below. Rear-face operation members 8a to 8f are provided on the lower side of the rear face.

The rear-face operation members 8a to 8f are, for example, a power button for switching ON/OFF of the power of the digital camera 1, a playback button for reproducing recorded captured images, a menu display button for switching the menu, etc.

In addition, the rear-face operation members 8a to 8f are a cross button that enables operations such as selection on the menu and selection of a playback image, a determination button for determining a selected item, a custom button that enables various kinds of operations to be set, etc.

A card cover 9 is disposed at the bottom of the digital camera 1, and is opened and closed when a semiconductor memory card 19 (see FIG. 2) is inserted and removed.

As illustrated in FIG. 2, the lens barrel unit 2 includes a focus lens 20a composed of a plurality of lens groups, a fixed lens 20b composed of a plurality of lens groups, and the like.

The lens barrel unit 2 also includes a diaphragm unit 22 for adjusting the aperture opening.

The lens barrel unit 2 includes a lens drive mechanism 161 for adjusting the focus (focal length) and a diaphragm drive mechanism 162 for controlling the F-number.

The image sensor 21 is composed of a complementary metal-oxide semiconductor (CMOS) sensor or a charge-coupled device (CCD) sensor, which captures an imaging light flux from the imaging lenses 20 and photoelectrically converts the captured imaging light flux. The image sensor 21 has an electronic shutter function.

A rectangular optical low-pass filter (not illustrated) made of material such as quartz is disposed in front of the image sensor 21.

A system control unit 300 includes an arithmetic unit such as a central processing unit (CPU) that controls the operation of each component of the digital camera 1.

The system control unit 300 executes a control program stored in the memory 164.

An electrical signal that has been output from the image sensor 21 is input to the system control unit 300. The system control unit 300 executes arithmetic processing on this electrical signal, and outputs the result to the display 210.

Information from a main body part acceleration sensor 151 and a display part acceleration sensor 221 is input to the system control unit 300.

Details will be described below. A power supply 18 is a secondary battery constituted by a battery pack housed inside the digital camera 1.

A power supply circuit 163 converts the voltage of the power supply 18 into a voltage necessary for each component of the digital camera 1, and supplies power to each component. The semiconductor memory card 19 is attachable to and detachable from the digital camera 1, and has a function of recording captured images.

### (Exploded Perspective View of Digital Camera 1)

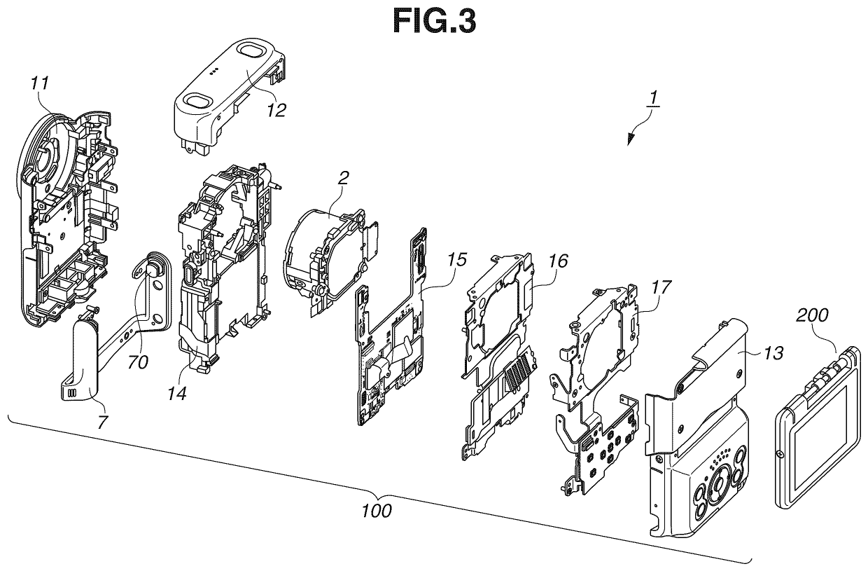

A configuration of the digital camera 1, which is the imaging apparatus according to the present disclosure, will be described with reference to FIG. 3.

FIG. 3 is an exploded perspective view of the digital camera 1. The digital camera 1 includes: a main body part 100 including the lens barrel unit 2; and the display part 200.

The exterior of the main body part 100 is formed by a front cover unit 11, a top cover unit 12, a rear cover unit 13, and the stand unit 7 having a stand hinge 70 that generates torque during a rotation operation.

The main body part 100 includes the lens barrel unit 2, a base member unit 14, a main body part electronic circuit board 15, a heat transfer sheet metal unit 16, and a structural sheet metal unit 17.

The base member unit 14 houses the power supply 18 (a rechargeable battery pack), which is not illustrated. The base member unit 14 and the structural sheet metal unit 17 sandwich and hold the lens barrel unit 2 via a rubber member (not illustrated).

### (Exploded Perspective View of Display Part 200)

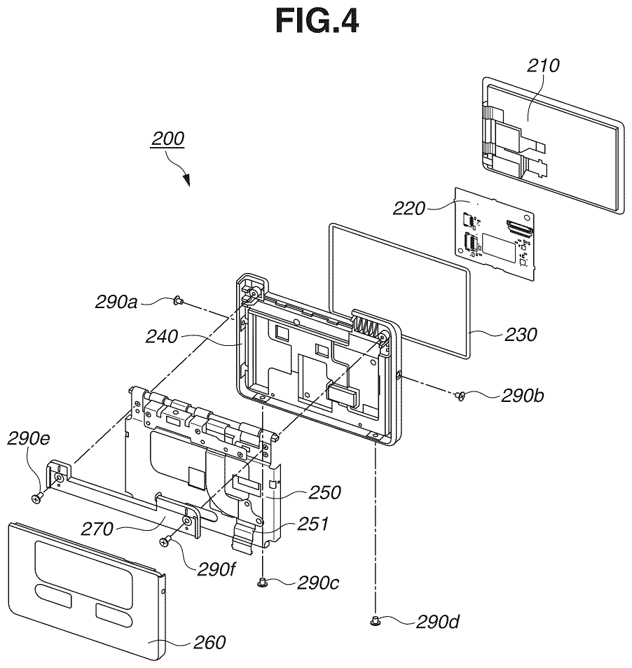

A configuration of the display part 200 according to the present disclosure will be described with reference to FIG. 4. FIG. 4 is an exploded perspective view of the display part 200.

The display 210 includes an LCD, an OLED display, or the like that displays a live-view image captured by the image sensor 21 and arithmetically processed by the system control unit 300. The display also displays settings of the main body part 100 and playback of a captured image.

A display part electronic circuit board 220 serves to relay electrical signals, is electrically connected to the display 210, and is fixed to the rear face of the display 210 with a double-sided tape or the like (not illustrated).

The display 210 is fixed to a display part surface cover 240 with a display-fixing double-sided tape 230.

A hinge unit 250 enables the rotational operation of the display part 200, and includes a flexible circuit board 251 for electrically connecting the main body part electronic circuit board 15 and the display part electronic circuit board 220.

The hinge unit 250 is assembled to the display part surface cover 240, is covered by a display part rear cover 260 and a display part hinge cover 270, and is fastened by display part exterior screws 290a to 290f from the side surfaces. Thus, the display part 200 is completed.

### (Locations of Acceleration Sensors)

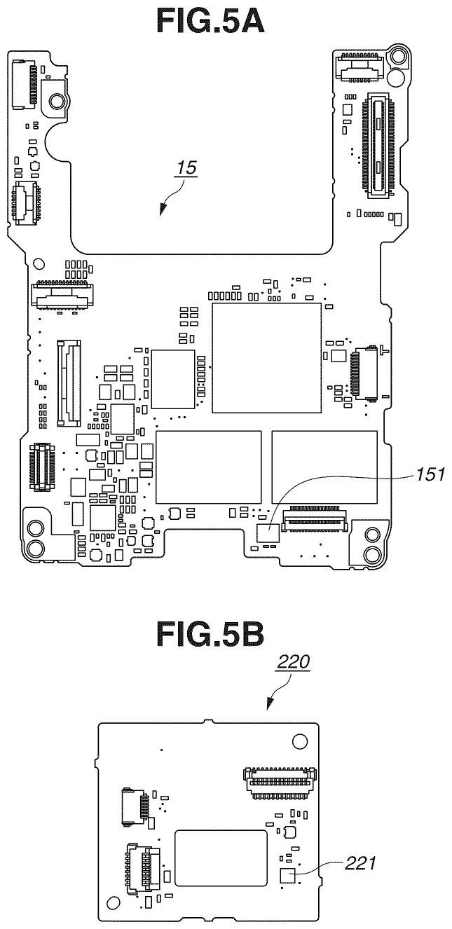

The locations of the acceleration sensors according to the present disclosure will be described with reference to FIGS. 5A and 5B. FIG. 5A is a rear view of the main body part electronic circuit board 15. FIG. 5B is a front view of the display part electronic circuit board 220.

As illustrated in FIG. 5A, the main body part acceleration sensor 151 is mounted on the main body part electronic circuit board 15. As illustrated in FIG. 5B, the display part acceleration sensor 221 is mounted on the display part electronic circuit board 220.

Although FIGS. 5A and 5B illustrate the locations of the main body part acceleration sensor 151 and the display part acceleration sensor 221, the main body part acceleration sensor 151 and the display part acceleration sensor 221 may be freely positioned on the respective electronic circuit boards in the main body part 100 and the display part 200.

The acceleration sensors are used to detect the opening/closing angle of the display part 200 with respect to the main body part 100 as described below.

In a case of a magnetic detection method, which is often used in conventional display part opening/closing angle detection, a magnetic sensor and a magnet need to be disposed near the rotational axis of the display part.

In addition, the magnetic detection method could affect the size of the digital camera. However, in the case of the acceleration sensors, since the acceleration sensors have less restriction in their positions, the acceleration sensors can be optimally positioned so as not to affect the size of the digital camera.

The main body part acceleration sensor 151 and the display part acceleration sensor 221 may be the same type of acceleration sensors or different types of acceleration sensors. That is, since the accuracy of the sensors can be selected as needed, the cost can be minimized.

Although the main body part acceleration sensor 151 and the display part acceleration sensor 221 are used as the posture detection sensors according to the present embodiment, a velocity sensor such as a gyroscope may be used instead of an acceleration sensor.

The acceleration may be calculated by detecting the gravitational velocity with a velocity sensor and differentiating the detected velocity.

### (Detailed Block Diagram Relating to Acceleration Sensors and Display Part)

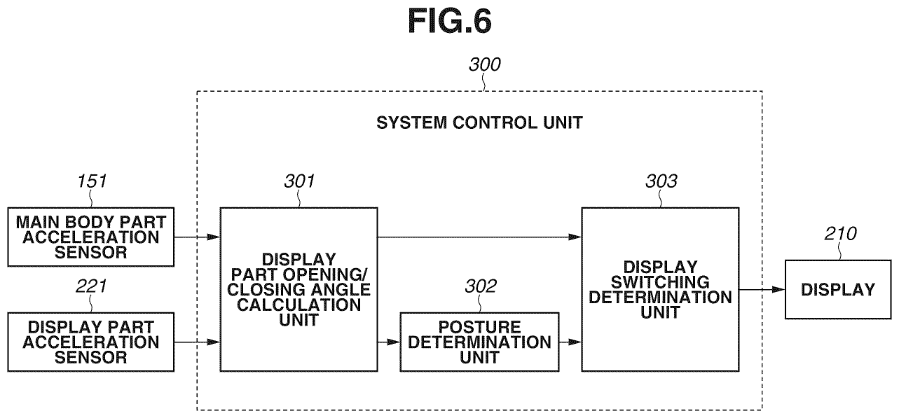

A functional configuration relating to the acceleration sensors and the display part according to the present disclosure will be described with reference to FIG. 6.

FIG. 6 is a detailed block diagram relating to the acceleration sensors and the display part. Acceleration signals from the main body part acceleration sensor 151 and the display part acceleration sensor 221 are input to the system control unit 300.

The input acceleration signals are input to a display part opening/closing angle calculation unit 301 in the system control unit 300.

The display part opening/closing angle calculation unit 301 calculates a tilt angle from the input acceleration signals, and calculates a display part opening/closing angle of the display part 200 with respect to the main body part 100.

Details will be described below. A posture determination unit 302 and a display switching determination unit 303 determine a display method, and an image is displayed on the display 210 based on the determination result.

### (Display Part Opening/Closing Angle Calculation Method)

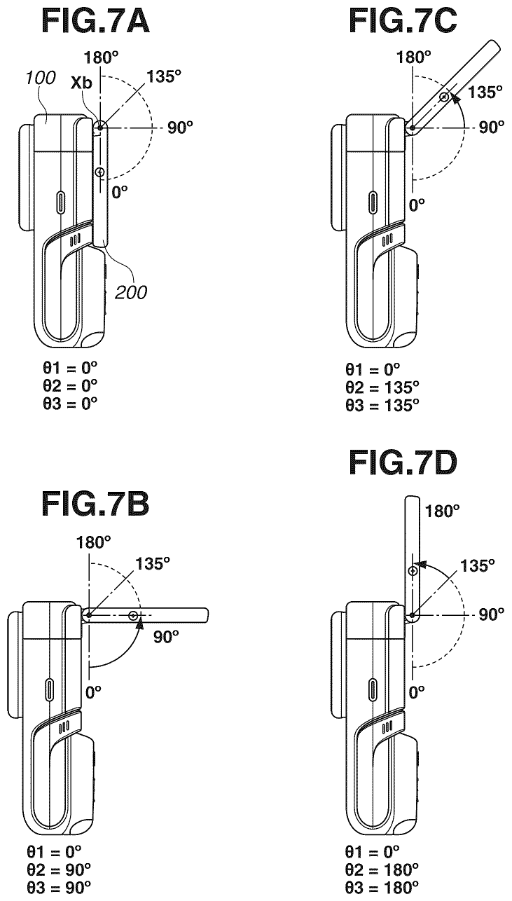

The display part opening/closing angle according to the present disclosure will be described with reference to FIGS. 7A to 7D, and the calculation method thereof will be described.

FIGS. 7A to 7D are each a right side view of the digital camera 1, and each illustrate an open/closed state of the display part 200. How the display part 200 is gradually opened is illustrated from FIG. 7A to FIG. 7D.

FIG. 7A illustrates the display part 200 in the closed state. That is, the display part opening/closing angle θ3 is 0°.

FIG. 7B illustrates the display part 200 in a state between the open state and the closed state, and in this state, the display part opening/closing angle θ3 is 90°. FIG. 7C illustrates the display part 200 in a state between the open state and the closed state, and in this state, the display part opening/closing angle θ3 is 135°.

FIG. 7D illustrates the display part 200 in the open state. That is, the display part opening/closing angle θ3 is 180°. When the display part opening/closing angle θ3 is between 0° and 90°, the display part 200 is determined to be in the closed state. When the display part opening/closing angle θ3 is between 135° and 180°, the display part 200 is determined to be in the open state.

When the display part opening/closing angle θ3 is between 90° and 135°, the display part 200 is determined to be in the middle of transition from the closed state to the open state. The boundaries of the states, which are 90° and 135°, are adjustable and can be set to any angles.

If the user operates the display part 200 in the opening direction and the closing direction, frequent switching of the display occurs near the boundaries, and the user finds it difficult to view the image. To solve this problem, each boundary in the closing direction is set to approximately 5° larger than its corresponding boundary in the opening direction (hysteresis characteristics).

This can prevent frequent switching of the display.

The digital camera 1 has an acceleration sensor in each of the main body part 100 and the display part 200.

Therefore, tilt angles (01 and 02) of the main body part 100 and the display part 200, respectively, are calculated from the acceleration signals (the acceleration in the Y-axis direction and the acceleration in the Z-axis direction) acquired from their respective acceleration sensors, and the relative angle of the display part 200 with respect to the main body part 100 is calculated.

When the display part 200 is opened as illustrated in FIGS. 7A to 7D, the display part 200 is opened in the upward direction with respect to the main body part 100.

Assuming that the gravitational acceleration direction is 0°, the main body part tilt angle θ1 and the display part tilt angle θ2 are each represented by a positive value when the display part 200 is rotated in the counterclockwise direction as viewed from the right side of the digital camera 1. The main body part tilt angle θ1 and the display part tilt angle θ2 are each represented by a negative value when the display part 200 is rotated in the clockwise direction as viewed from the right side of the digital camera 1.

The tilt angle in the upward direction is calculated in accordance with Equation (1).

Tilt angle(deg)=arctan(Z-axis acceleration÷Y-axis acceleration)×180÷π (1)

By calculating the main body part tilt angle θ1 (deg) and the display part tilt angle θ2 (deg) in accordance with Equation (1), the display part opening/closing angle θ3 (deg) of the display part 200 relative to the main body part 100 is calculated in accordance with Equation (2).

Display part opening/closing angle θ3(deg)=display part tilt angle θ2−main body part tilt angle θ1 (2)

The display switching determination unit 303 can determine whether to display information in the normal display orientation or the inverted display orientation based on the value of the display part opening/closing angle θ3 obtained as described above, and the main body part tilt angle θ1 or the display part tilt angle θ2, and can display the image on the display 210.

For example, when the display part opening/closing angle is in the range from 0° to 90°, the normal display is determined, and when the display part opening/closing angle is in the range from 135° to 180°, the inverted display is determined.

Further, when the display part opening/closing angle is in the range from 90° to 135°, the posture of the camera is determined based on the main body part tilt angle θ1 or the display part tilt angle θ2, and whether to apply the normal display or the inverted display is determined in accordance with the determined posture.

### (Normal Display and Inverted Display of Display 210)

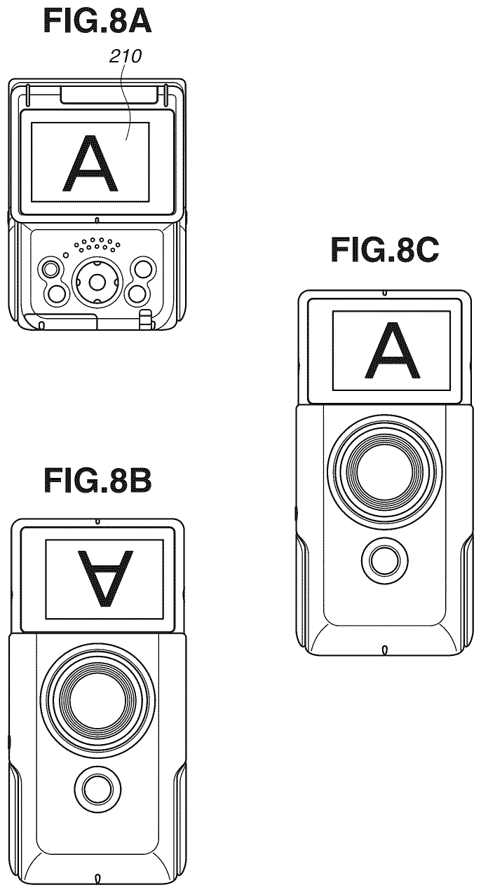

The display (the normal display and the inverted display) of the display 210 according to the present disclosure will be described with reference to FIGS. 8A to 8C. FIGS. 8A to 8C are a rear view and front views of the digital camera 1, and illustrate the normal display or the inverted display on the display 210.

The alphabet “A” is schematically illustrated as the display content, and the normal display or the inverted display is expressed by the orientation of the alphabet “A”.

When the upper side of the alphabet “A” is located closer to the rotational center axis of the display part 200, the display is the “normal display”, and when the lower side of the alphabet “A” is located closer to the rotational center axis of the display part 200, the display is the “inverted display”.

FIG. 8A is a rear view of the display part 200 in the closed state (θ3=0°). FIGS. 8B and 8C are front views of the display part 200 in the open state (θ3=180°).

The display state in FIG. 8A is the normal display. If the display part 200 is rotated to be in the open state with the display remaining in the normal display, the display becomes upside down as illustrated in FIG. 8B.

When the photographer performs self-photographing, such a display makes it difficult for the photographer to adjust the angle of view while viewing the display 210.

In this case, inverting the display as illustrated in FIG. 8C makes it easier for the photographer to adjust the angle of view while viewing the display 210.

This display state is the inverted display. Although the inverted display includes both vertical inversion and horizontal inversion, the horizontal inversion can be performed by switching ON/OFF of its setting on the digital camera 1.

### (Steps S701 to S711 Performed by Display Part Opening/Closing Angle Calculation Unit 301, Posture Determination Unit 302, and Display Switching Determination Unit 303)

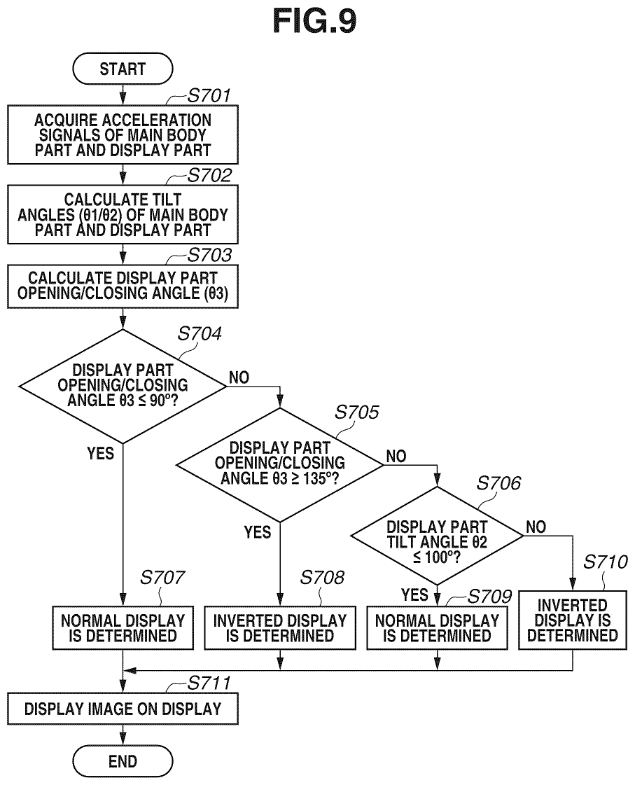

Steps S701 to S711 performed by the display part opening/closing angle calculation unit 301, the posture determination unit 302, and the display switching determination unit 303 according to the present disclosure will be described with reference to a flowchart illustrated in FIG. 9.

In step S701, the display part opening/closing angle calculation unit 301 acquires acceleration signals by using the main body part acceleration sensor 151 and the display part acceleration sensor 221.

In step S702, the display part opening/closing angle calculation unit 301 calculates the main body part tilt angle θ1 and the display part tilt angle θ2 in accordance with Equation (1). In step S703, the display part opening/closing angle calculation unit 301 calculates the display part opening/closing angle θ3 in accordance with Equation (2).

In step S704, the display switching determination unit 303 determines whether the display part opening/closing angle θ3 calculated in step S703 is 90° or less. If the display part opening/closing angle θ3 is 90° or less (YES in step S704), the process proceeds to step S707. In step S707, the display switching determination unit 303 determines that the display is the normal display.

If the display part opening/closing angle θ3 is 90° or greater (NO in step S704), the process proceeds to step S705. In step S705, the display switching determination unit 303 determines whether the display part opening/closing angle θ3 calculated in step S703 is 135° or greater.

If the display part opening/closing angle θ3 is 135° or greater (YES in step S705), the process proceeds to step S708. In step S708, the display switching determination unit 303 determines that the display is the inverted display.

If the display part opening/closing angle θ3 is 135° or less (NO in step S705), the process proceeds to step S706. In step S706, the posture determination unit 302 determines whether the display part tilt angle θ2 calculated in step S702 is 100° or less.

If the display part tilt angle θ2 is 100° or less (YES in step S706), the process proceeds to step S709. In step S709, the display switching determination unit 303 determines that the display is the normal display.

If the display part tilt angle θ2 is 100° or greater (NO in step S706), the process proceeds to step S710. In step S710, the display switching determination unit 303 determines that the display is the inverted display.

In step S711, based on the determinations in steps S707 to S710, the image is displayed on the display 210 in the normal display or the inverted display.

As described above, if the display part opening/closing angle θ3 is between 0° and 90°, the display switching determination unit 303 detects the closed state and determines that the display is the normal display.

If the display part opening/closing angle θ3 is between 135° and 180°, the display switching determination unit 303 detects the open state and determines that the display is the inverted display.

If the display part opening/closing angle θ3 is between 90° and 135°, the display switching determination unit 303 detects a state between the closed state and the open state, and the normal display and the inverted display are switched in accordance with the posture of the camera.

If the display part tilt angle θ2 is between 0° and 100°, the display switching determination unit 303 determines that the display is the normal display. If the display part tilt angle θ2 is between 100° and 180°, the display switching determination unit 303 determines that the display is the inverted display.

That is, the normal display and the inverted display can be switched accordance with the display part opening/closing angle and the display part tilt angle.

(Change in Display State of Display Part in Accordance with Display Part Opening/Closing Angle and Posture (Tilt Angle))

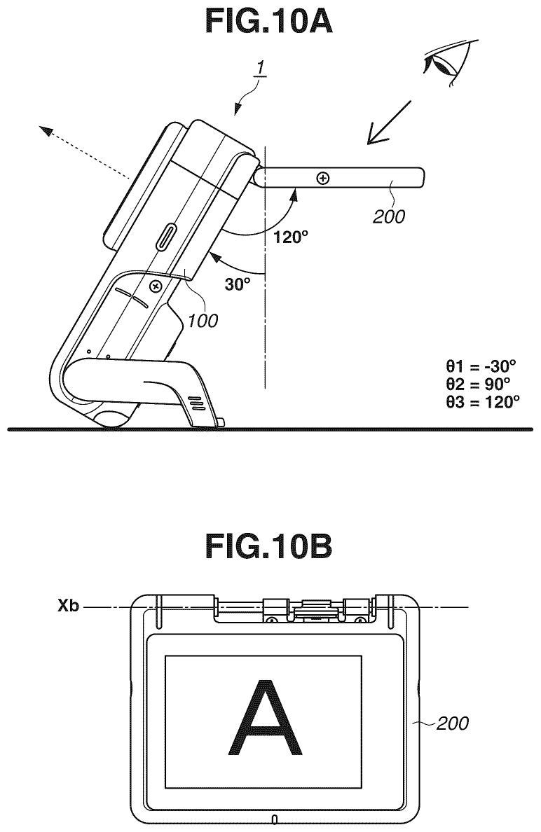

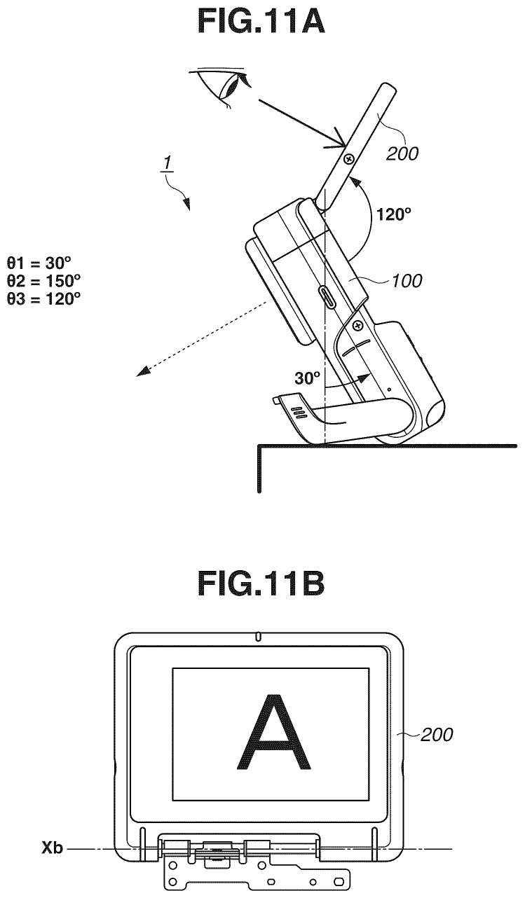

Change in the display state of the display part in accordance with the display part opening/closing angle and the posture (the tilt angle) of the digital camera 1 will be described with reference to FIGS. 10A, 10B, 11A, and 11B.

FIGS. 10A and 10B illustrate the digital camera 1 in a state of upward angle photographing and the corresponding state of the display part 200. FIG. 10A is a right side view of the digital camera 1 in the state of upward angle photographing.

The optical axis of the digital camera 1 is directed upward by rotating the stand unit 7. That is, the digital camera 1 is brought in the state of upward angle photographing.

Since the main body part tilt angle θ1 is −30°, the optical axis is directed upward by 30°. When the photographer performs image capturing while viewing the display part 200 from the back of the digital camera 1, the display part opening/closing angle θ3 is 120°.

This is an example of the display part opening/closing angle at which the photographer can easily view the display and perform a touch operation. In this case, the display part tilt angle θ2 is 90°.

FIG. 10B illustrates only the display part 200 in the state illustrated in FIG. 10A.

According to the flowchart in FIG. 9, since 03=120° and 02=90°, the display of the display part 200 is determined to be the normal display in step S709. That is, a state desired by the photographer can be achieved.

Although not illustrated, when the photographer performs image capturing while viewing the display part 200 from the front of the digital camera 1, the photographer can open the display part opening/closing angle θ3 to be closer to 180°. In this way, the photographer can change the orientation of the display part 200 to an orientation such that the photographer can easily view the display.

Further, when the display part opening/closing angle θ3 is rotated to 135° or greater, the display can be switched to the inverted display. Thus, a state desired by the photographer can be achieved.

FIGS. 11A and 11B illustrate the digital camera 1 in a state of downward angle photographing and the corresponding state of the display part 200. FIG. 11A is a right side view of the digital camera 1 in the state of downward angle photographing.

The optical axis of the digital camera 1 is directed downward by rotating the stand unit 7. That is, the digital camera 1 is brought in the state of downward angle photographing.

Since the main body part tilt angle θ1 is 30°, the optical axis is directed downward by 30°. When the photographer performs image capturing while viewing the display part 200 from the front of the digital camera 1, the display part opening/closing angle θ3 is 120°.

This is an example of the display part opening/closing angle at which the photographer can easily view the display and perform a touch operation. In this case, the display part tilt angle θ2 is 150°.

FIG. 11B illustrates only the display part 200 in the state illustrated in FIG. 11A.

According to the flowchart in FIG. 9, since 03=120° and 02=150°, the display of the display part 200 is determined to be the inverted display in step S710. That is, a state desired by the photographer can be achieved.

Although not illustrated, when the photographer performs image capturing while viewing the display part 200 from the back of the digital camera 1, the photographer can close the display part opening/closing angle θ3 to be closer to 0°. In this way, the photographer can change the orientation of the display part 200 to an orientation such that the photographer can easily view the display.

Further, when the display part opening/closing angle θ3 is rotated 90° or less, the display can be switched to the normal display. Thus, a state desired by the photographer can be achieved.

As described above, a display as desired by the photographer can be obtained in accordance with the direction of the optical axis of the digital camera 1 and the opening/closing angle of the display part 200.

The present embodiment has been described based on an example in which the display part opening/closing angle is divided into three ranges, and the closing detection, the posture detection, and the opening detection are performed. The boundaries of the display part opening/closing angle are set to 90° and 135°, and the boundary of the display part tilt angle is set to 100°. However, these settings are merely an example.

In practice, the present disclosure is not limited to these settings. That is, the settings can be freely adjusted. In addition, the photographer can manually change the settings of the boundary angles to obtain a desired state. For example, the boundaries of the display part opening/closing angle may be set to 80° and 145°, so as to widen the range of the angles at which the posture can be detected. Alternatively, the boundaries of the display part opening/closing angle may also be set to 100° and 125°, so as to narrow the range of angles at which the posture can be detected.

Further, the posture detection according to the present embodiment has been described by using the display part tilt angle θ2. However, when the display part opening/closing angle θ3 is constant, the main body part tilt angle θ1 can also be calculated easily by Equation (2). Thus, the posture detection may be performed by using either one of the tilt angles.

The features of the present embodiment will be listed below.

The following description will be made with reference to FIGS. 5A and 5B, FIGS. 7A to 7D, and FIG. 9.

The imaging apparatus includes a main body part 100 configured to include an imaging unit 2, a display part 200 configured to change its posture with respect to the main body part 100, and a rotation unit 250 configured to rotatably hold the display part 200 with respect to the main body part 100.

The imaging apparatus also includes a first posture detection unit 151 configured to detect information about gravitational acceleration applied to the main body part 100, and a second posture detection unit 221 configured to detect information about gravitational acceleration applied to the display part 200.

The imaging apparatus further includes a calculation unit 301 configured to calculate an opening/closing angle θ3 of the display part 200 with respect to the main body part 100 based on acceleration signals acquired from the first posture detection unit 151 and the second posture detection unit 221.

The opening/closing angle θ3 of the display part 200 is divided into a first opening/closing angle range 810, a second opening/closing angle range 820, and a third opening/closing angle range 830.

The third opening/closing angle range 830 is formed between the first opening/closing angle range 810 and the second opening/closing angle range 820.

In a case where the first opening/closing angle range 810 is determined by the calculation unit 301, a first display state is displayed on the display part 200.

In a case where the second opening/closing angle range 820 is determined, a second display state is displayed on the display part 200.

In a case where the third opening/closing angle range 830 is determined, the first display state or the second display state is displayed on the display part 200 in accordance with the tilt angle θ1 of the main body part 100 with respect to gravity or the tilt angle θ2 of the display part 200 with respect to gravity.

As the next feature, the first posture detection unit 151 and the second posture detection unit 221 are acceleration sensors.

Further, the tilt angle θ1 of the main body part 100 with respect to gravity and the tilt angle θ2 of the display part 200 with respect to gravity are calculated from acceleration signals acquired from their respective acceleration sensors, and the opening/closing angle θ3 of the display part 200 is calculated by calculating the difference between the tilt angle θ1 and the tilt angle θ2.

As the next feature, a first boundary, which is the boundary between the first opening/closing angle range 810 and the third opening/closing angle range 830, and a second boundary, which is the boundary between the second opening/closing angle range 820 and the third opening/closing angle range 830, are manually adjustable (FIGS. 7A to 7D).

### Second Embodiment

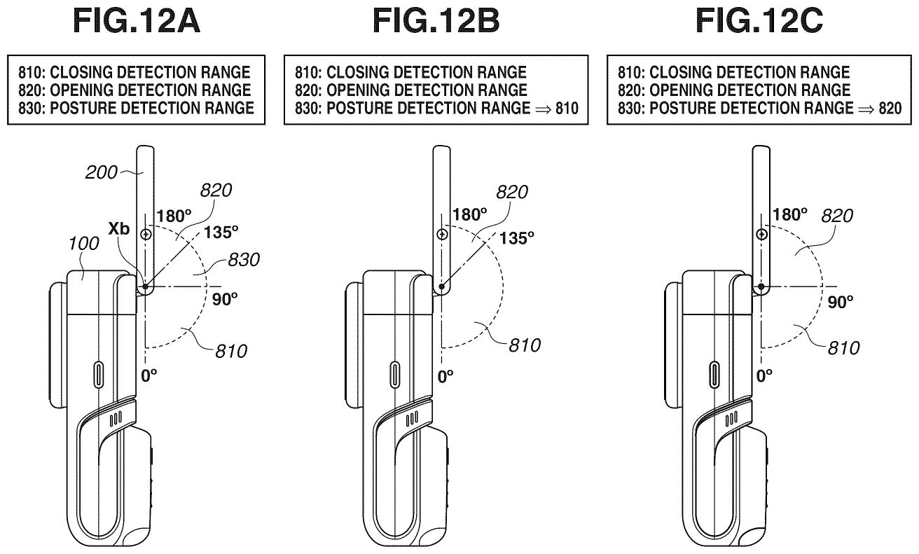

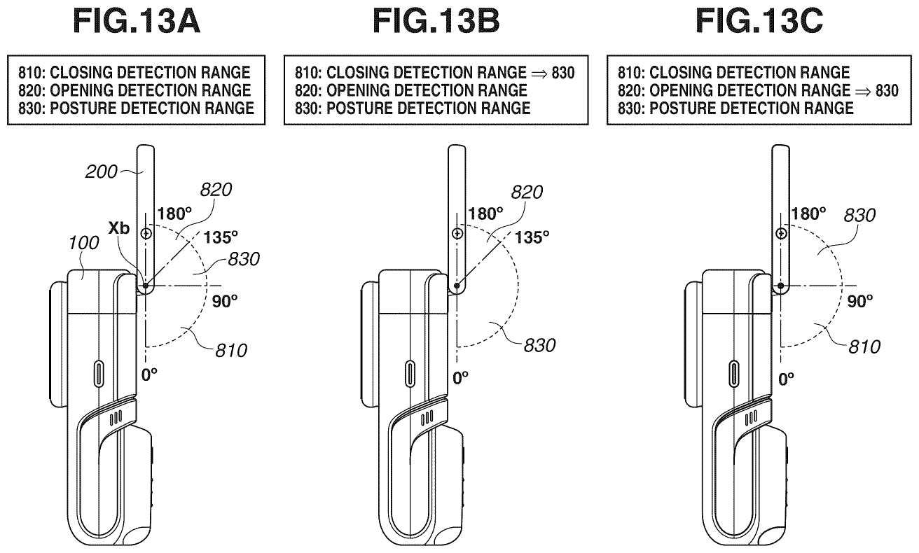

Change of the display part opening/closing angle detection range according to the first embodiment will be described with reference to FIGS. 12A to 12C, and FIGS. 13A to 13C.

Description of the same components as those of the first embodiment will be omitted, and different components will be described in detail. The components denoted by the same reference characters have the same functions.

### (Display Part Opening/Closing Angle Detection Range)

FIGS. 12A to 12C are each a side view of the digital camera 1, and each schematically illustrate the display part opening/closing angle detection range. In FIGS. 12A to 12C, the posture detection range is reduced by being replaced with another detection range.

FIG. 12A illustrates detection ranges according to the first embodiment.

A closing detection range 810 of the display part opening/closing angle θ3 is 0° to 90°. An opening detection range 820 of the display part opening/closing angle θ3 is 135° to 180°.

A posture detection range 830 of the display part opening/closing angle θ3 is 90° to 135°. FIG. 12B illustrates a change that has been made by manually replacing the posture detection range 830 in FIG. 12A with the closing detection range 810.

The boundary 135° can be manually changed. FIG. 12C illustrates a change that has been made by manually replacing the posture detection range 830 in FIG. 12A with the opening detection range 820.

The boundary 90° can be manually changed. Since the boundary 135° and the boundary 90° can be manually changed, FIG. 12B and FIG. 12C eventually have the same detection method.

As a result, a simple detection method based on the closing detection and the opening detection is obtained. Unlike a conventional magnetic detection method, the detection boundaries can be manually changed. In this way, the photographer can set a desired display.

### (Display Part Opening/Closing Angle Detection Method)

FIGS. 13A to 13C are each a side view of the digital camera 1, and each schematically illustrate a display part opening/closing angle detection method. In FIGS. 13A to 13C, the posture detection range is enlarged by replacing another detection range with the posture detection range.

FIG. 13A illustrates the detection ranges according to the first embodiment. The closing detection range 810 of the display part opening/closing angle θ3 is 0° to 90°. The opening detection range 820 of the display part opening/closing angle θ3 is 135° to 180°.

The posture detection range 830 of the display part opening/closing angle θ3 is 90° to 135°. FIG. 13B illustrates a change that has been made by manually replacing the closing detection range 810 in FIG. 13A with the posture detection range 830.

The boundary 135° can be manually changed. FIG. 13C illustrates a change that has been made by manually replacing the opening detection range 820 in FIG. 13A with the posture detection range 830.

The boundary 90° can be manually changed. This simple detection method is based on the opening detection and the posture detection or based on the closing detection and posture detection. That is, this detection method can include either the opening detection or the closing detection, and the posture detection.

In this way, the photographer can set a desired display.

### (Display Part Opening/Closing Angle Detection Method)

FIGS. 13A to 13C are each a side view of the digital camera 1, and each schematically illustrate a display part opening/closing angle detection method. In FIGS. 13A to 13C, the posture detection range is enlarged by replacing another detection range with the posture detection range.

FIG. 13A illustrates the detection ranges according to the first embodiment. The closing detection range 810 of the display part opening/closing angle θ3 is 0° to 90°. The opening detection range 820 of the display part opening/closing angle θ3 is 135° to 180°.

The posture detection range 830 of the display part opening/closing angle θ3 is 90° to 135°. FIG. 13B illustrates a change that has been made by replacing the closing detection range 810 in FIG. 13A with the posture detection range 830.

The boundary 135° can be changed. FIG. 13C illustrates a change that has been made by replacing the opening detection range 820 in FIG. 13A with the posture detection range 830.

The boundary 90° can be changed. This simple detection method is based on the opening detection and the posture detection or based on the closing detection and posture detection. That is, this detection method can include either the opening detection or the closing detection, and the posture detection.

In this way, the photographer can set a desired display.

The features of the present embodiment are listed below.

The following description will be made with reference to FIG. 12A to FIG. 12C.

The imaging apparatus is capable of changing a display state of the display part 200 in the third opening/closing angle range 830 to be the same as that in the first opening/closing angle range 810.

Alternatively, the imaging apparatus is capable of changing the display state of the display part 200 in the third opening/closing angle range 830 to be the same as that in the second opening/closing angle range 820.

The following description will be made with reference to FIGS. 13A to 13C.

The imaging apparatus is capable of changing the display state of the display part in the first opening/closing angle range 810 to be the same as that in the third opening/closing angle range 830.

Alternatively, the imaging apparatus is capable of changing the display state of the display part in the second opening/closing angle range 820 to be the same as that in the third opening/closing angle range 830.

Suitable embodiments of the present disclosure have thus been described. However, the present disclosure is not limited to these embodiments, and various modifications can be made within the scope of the gist of the present disclosure.

For example, although the details of the embodiments have been described by using a digital camera having a vertical layout, the same effects can be obtained with a digital camera having a horizontal layout.

Further, the embodiments have been described based on an example in which the camera is tilted by using the stand and performs image capturing. However, the same effects can be obtained even in a case where a camera without a stand is tilted by using a tripod or the like and performs image capturing.

Although the details of the embodiments have been described by using a lens-integrated digital camera, the same effects can be obtained with an interchangeable-lens digital camera.

Suitable embodiments of the present disclosure will be described.

### (Configuration 1)

An imaging apparatus including:
a main body part 100 configured to include an imaging unit 2;
a display part 200 configured to change its posture with respect to the main body part 100;
a rotation unit 250 configured to rotatably hold the display part 200 with respect to the main body part 100;
a first posture detection unit 151 configured to detect information about gravitational acceleration applied to the main body part 100;
a second posture detection unit 221 configured to detect information about gravitational acceleration applied to the display part 200; and
a calculation unit 301 configured to calculate an opening/closing angle θ3 of the display part 200 with respect to the main body part 100 based on acceleration signals acquired from the first posture detection unit 151 and the second posture detection unit 221,
wherein the opening/closing angle θ3 of the display part 200 is divided into a first opening/closing angle range 810, a second opening/closing angle range 820, and a third opening/closing angle range 830,
wherein the third opening/closing angle range 830 is formed between the first opening/closing angle range 810 and the second opening/closing angle range 820,
wherein, in a case where the first opening/closing angle range 810 is determined by the calculation unit 301, a first display state is displayed on the display part 200,
wherein, in a case where the second opening/closing angle range 820 is determined by the calculation unit 301, a second display state is displayed on the display part 200, and
wherein, in a case where the third opening/closing angle range 830 is determined by the calculation unit 301, the first display state or the second display state is displayed on the display part 200 in accordance with a tilt angle θ1 of the main body part 100 with respect to gravity or a tilt angle θ2 of the display part 200 with respect to gravity.

### (Configuration 2)

The imaging apparatus according to configuration 1,
wherein the first posture detection unit 151 and the second posture detection unit 221 are acceleration sensors, and
wherein the tilt angle θ1 of the main body part 100 with respect to gravity and the tilt angle θ2 of the display part 200 with respect to gravity are calculated from acceleration signals acquired from the acceleration sensors, and the opening/closing angle θ3 of the display part 200 is calculated by calculating a difference between the tilt angle θ1 of the main body part 100 with respect to gravity and the tilt angle θ2 of the display part 200 with respect to gravity.

### (Configuration 3)

The imaging apparatus according to configuration 1 or 2, wherein a first boundary, which is a boundary between the first opening/closing angle range 810 and the third opening/closing angle range 830, and a second boundary, which is a boundary between the second opening/closing angle range 820 and the third opening/closing angle range 830, are adjustable.

### (Configuration 4)

The imaging apparatus according to any one of configurations 1 to 3, wherein the imaging apparatus is capable of changing a display state of the display part 200 in the third opening/closing angle range 830 to be a same as a display state of the display part 200 in the first opening/closing angle range 810 or changing a display state of the display part 200 in the third opening/closing angle range 830 to be a same as a display state of the display part 200 in the second opening/closing angle range 820.

### (Configuration 5)

The imaging apparatus according to any one of configurations 1 to 4, wherein the imaging apparatus is capable of changing a display state of the display part 200 in the first opening/closing angle range 810 to be a same as a display state of the display part 200 in the third opening/closing angle range 830 or changing a display state of the display part 200 in the second opening/closing angle range 820 to be a same as a display state of the display part 200 in the third opening/closing angle range 830.

The present disclosure is not limited to the above-described embodiments. Various modifications and variations are possible without departing from the spirit and scope of the present disclosure. Thus, the following claims are attached to make the scope of the present disclosure public.

According to the present disclosure, it is possible to provide an imaging apparatus capable of obtaining desired display matching the direction of the optical axis of the imaging apparatus and the opening/closing angle of a display part.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An imaging apparatus comprising:
a main body part configured to include an imaging unit;
a display part configured to change its posture with respect to the main body part;
a rotation unit configured to rotatably hold the display part with respect to the main body part;
a first detection unit configured to detect information about gravitational acceleration applied to the main body part;
a second detection unit configured to detect information about gravitational acceleration applied to the display part; and
a calculation unit configured to calculate an opening/closing angle of the display part with respect to the main body part based on acceleration signals acquired from the first detection unit and the second detection unit,
wherein the opening/closing angle of the display part is divided into a first opening/closing angle range, a second opening/closing angle range, and a third opening/closing angle range,
wherein the third opening/closing angle range is formed between the first opening/closing angle range and the second opening/closing angle range,
wherein, in a case where the first opening/closing angle range is determined by the calculation unit, a first display state is displayed on the display part,
wherein, in a case where the second opening/closing angle range is determined by the calculation unit, a second display state is displayed on the display part, and
wherein, in a case where the third opening/closing angle range is determined by the calculation unit, the first display state or the second display state is displayed on the display part in accordance with a tilt angle of the main body part with respect to gravity or a tilt angle of the display part with respect to gravity.

2. The imaging apparatus according to claim 1,
wherein the first detection unit and the second detection unit are acceleration sensors, and
wherein the tilt angle of the main body part with respect to gravity and the tilt angle of the display part with respect to gravity are calculated from acceleration signals acquired from the acceleration sensors, and the opening/closing angle of the display part is calculated by calculating a difference between the tilt angle of the main body part with respect to gravity and the tilt angle of the display part with respect to gravity.

3. The imaging apparatus according to claim 1, wherein a first boundary, which is a boundary between the first opening/closing angle range and the third opening/closing angle range, and a second boundary, which is a boundary between the second opening/closing angle range and the third opening/closing angle range, are adjustable.

4. The imaging apparatus according to claim 1, wherein the imaging apparatus is capable of changing a display state of the display part in the third opening/closing angle range to be a same as a display state of the display part in the first opening/closing angle range or changing a display state of the display part in the third opening/closing angle range to be a same as a display state of the display part in the second opening/closing angle range.

5. The imaging apparatus according to claim 1, wherein the imaging apparatus is capable of changing a display state of the display part in the first opening/closing angle range to be a same as a display state of the display part in the third opening/closing angle range or changing a display state of the display part in the second opening/closing angle range to be a same as a display state of the display part in the third opening/closing angle range.
